(19) United States
(12) Patent Application Publication
(10) Pub. No.: US 2011/0271302 A1
(43) Pub. Date: Nov. 3, 2011

(54) CONTENT SELECTION ACCELERATION SYSTEM AND METHOD

(75) Inventors: Eric Stephen Carlsgaard, Zionsville, IN (US); Mark Gilmore Mears, Zionsville, IN (US); James Duane Tenbarge, Fishers, IN (US)

(73) Assignee: Shenzhen TCL New Technology Ltd., Shekou, Shenzen, Guangdong (CN)

(21) Appl. No.: 12/734,108

(22) PCT Filed: Oct. 31, 2007
(86) PCT No.: PCT/US2007/003175

§ 371 Date: Apr. 9, 2010

(30) Foreign Application Priority Data
Oct. 18, 2007 (CN) 200710124026.7

(51) Int. Cl. H04N 5/445

(52) U.S. Cl. 725/39

(57) ABSTRACT

There is provided a system and method for channel selection. An exemplary method comprises receiving a channel scan rate command signal that indicates a first channel scan rate or a second channel scan rate. The exemplary method further comprises scanning through a user interface display of a channel list at the first channel scan rate if the first channel scan rate is indicated by the channel scan rate command signal and scanning through the user interface display of the channel list at the second channel scan rate if the second channel scan rate is indicated by the channel scan rate command signal.

### FIELD OF THE INVENTION

The present invention relates generally to digital televisions. More particularly, the present invention relates to a method of improved interaction with a user interface such that multiple speeds of navigation through video input channels can be used to move more quickly to a desired selection.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In a digital TV, including cable systems and satellite systems, there are large numbers of channels, often including a mix of digital and analog channels. Often, a viewer wants to move quickly through the channels to view the desired channel. The selection process may be slowed if a complicated remote is needed to access the user interface displayed on the screen.

Many known methods of channel selection employ a “select and repeat” process that requires the entry of several commands. Such systems typically offer almost no increase in channel selection speed relative to separate control changes by the consumer. As a result, consumers frequently choose to directly enter the channel numbers using number buttons to jump-move quickly to a desired channel.

Direct entry of channel information is not possible, however, if the user has a simplified remote control that does not have numbered buttons for channel entry. A system and method for moving more quickly through a user interface that displays channel options is desirable, especially in light of the longer tune times needed by digital tuners.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a graphical representation of an on-screen user selection interface in accordance with an exemplary embodiment of the present invention;

FIG. 3 is a graphical representation of an on-screen user selection interface in accordance with an exemplary embodiment of the present invention;

FIG. 4, which comprises FIGS. 4a-4e, is a graphical representation of a remote control device with a joy-stick for use in accordance with an exemplary embodiment of the present invention; and

FIG. 5 is a process flow diagram of a method in accordance with an exemplary embodiment of the present invention; and

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

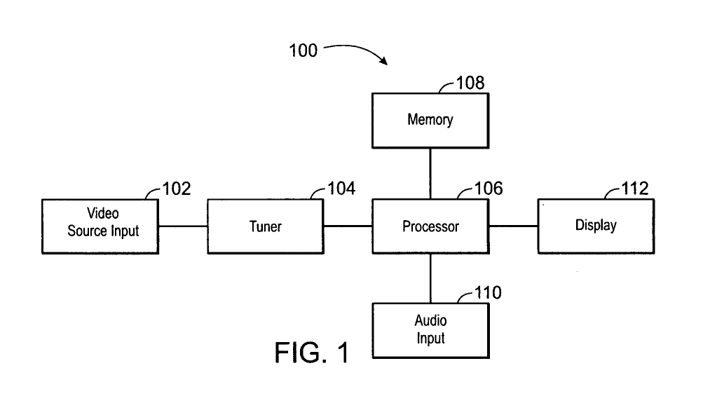

FIG. 1 is a block diagram of an electronic device in accordance with an exemplary embodiment of the present invention. The electronic device is generally referred to by the reference number 100. The electronic device 100 (a television, for example) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

A video source input 102 may comprise a plurality of source types including any of the following: an antenna input for receiving over the air television channels, an input for receiving cable television channels, a computer interface, a memory card reader, an input for receiving information from an optical disk or the like. Additionally, an audio input 110 is adapted to receive audio input which may or may not correspond to information received by way of the video source input 102. Those of ordinary skill in the art will appreciate that, although only one video source input 102 and only one audio source input 110 is shown, the electronic device 100 may include multiple video and/or audio source inputs.

A tuner subsystem 104 is adapted to tune a particular video program from a broadcast signal received from the video source input 102. Those of ordinary skill in the art will appreciate that video input signals that are not received as part of a broadcast spectrum, such as data from a DVD player, for example, may bypass the tuner 104 because tuning is not required to isolate a video program associated with those signals.

A processor 106 is adapted to control the overall operation of the electronic device 100. A memory 108 may be associated with the processor 106 to hold machine-readable computer code that causes the processor 106 to control the operation of the electronic device 100 in the manner described above and below.

The electronic device 100 includes a display subsystem 112, which may comprise a liquid crystal (LCD) display, a liquid-crystal-on-silicon (LCOS) display, a digital light projection (DLP) display or any other suitable display type. The display subsystem 112 may include a lighting source (not shown) that is used to generate a visible image on the display.

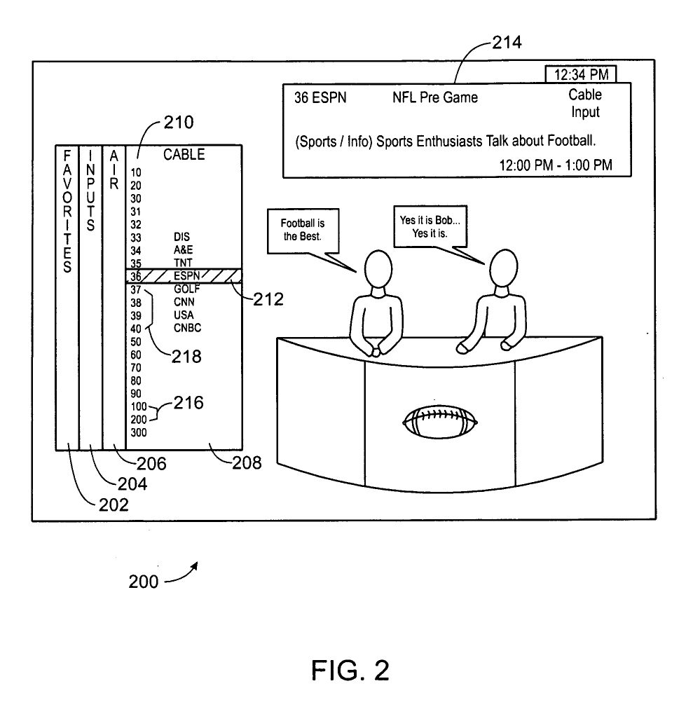

FIG. 2 is a graphical representation of an on-screen user selection interface in accordance with an exemplary embodiment of the present invention. The graphical representation of the on-screen user selection interface is generally referred to by the reference number 200. In FIG. 2, the on-screen user selection interface 200 comprises a plurality of graphical tabs: favorites 202, inputs 204 (video 1, video 2, etc.), over-the-air channel inputs 206, and cable channel inputs 208. A user may navigate to Individual tabs using, for example, buttons on the television or a remote control. The processor is further adapted to display a list of channels 210 associated with the tab that is selected to be displayed. In the exemplary embodiment shown in FIG. 2, the cable channel input tab 208 is displayed, so the channel listing shown corresponds to cable television channels. The list 210 comprises a currently selected channel 212, which may be indicated by shading, highlighting or the like. In FIG. 2, the selected channel 212 is cable channel 36 (ESPN). The channel list 210 includes a listing of all channels within a specific range of the selected channel 212. For example, the channel list 210 contains an entry for all channels between channel 30 and channel 40 because those channels are in the same group of ten channels (a “decade”) as the currently selected channel 212. In the exemplary embodiment shown in FIG. 2, a channel label (ESPN, DIS, A&E or the like) is displayed for channels in close proximity to the currently selected channel 212.

For channels that are further away from the currently selected channel 212, not every channel appears in the channel list 210. For example, only one entry appears in the channel list 210 for each of the channel decades between the decade that includes the currently selected channel 212 and channel 100. In other words, only one entry is shown in the channel list 210 for channels in the forties, fifties, sixties, seventies, eighties and nineties. Thereafter, the channel list 210 only contains a range indication 216 for each 100 channels (100, 200, 300, etc.). Alternatively, the range indication 216 may include a horizontal line or other label instead of indicating far-away channels with numbers, by tens, twenties, hundreds, or the like.

The user may select a new current channel by scrolling through the channel list 210, which may update as the user moves up or down the list of available channels. Moreover, if the user scrolls down in FIG. 2, the channel list 210 may be updated to include all channels in the forties when channel forty is reached in the scrolling process. In this manner, an exemplary embodiment of the present invention allows a user to rapidly scroll through a large number of channels without the need to directly enter any specific channel numbers.

Additionally, in accordance with one aspect of an exemplary embodiment of the present invention, a content information window 214 displays additional information available about the currently selected channel 212 after tuning has occurred. This additional information could originate from a guide service, from a CableCARD, from a digital data stream or any other suitable source of program information. The information shown in the content information window 214 may comprise a wide range of information. Examples of information that may be included in the content information window 214 include the channel number, the name of a current program, an identification of a local affiliate, the time and date, a rating, closed caption and audio options, program title, description, resolution, aspect ratio (normal versus wide screen) or the like. This more complete population of information in the content information window 214 is a confirmation to the viewer that the desired channel has been selected and tuned.

In accordance with an exemplary embodiment of the present invention, navigation of channels is accelerated as the tuning process is not initiated while channels are being scanned by the viewer. As used herein, the terms “scanning” or “scrolling” mean that a user is successively moving through a list of channels being displayed on a user interface in an effort to identify a channel to view. Tuning to the desired channel does not, occur as the user scrolls through the channel list 210. Because tuning does not take place until a new currently selected channel is affirmatively chosen by the user, the user is not subjected to delays as each channel scrolled through the channel list 210 is tuned.

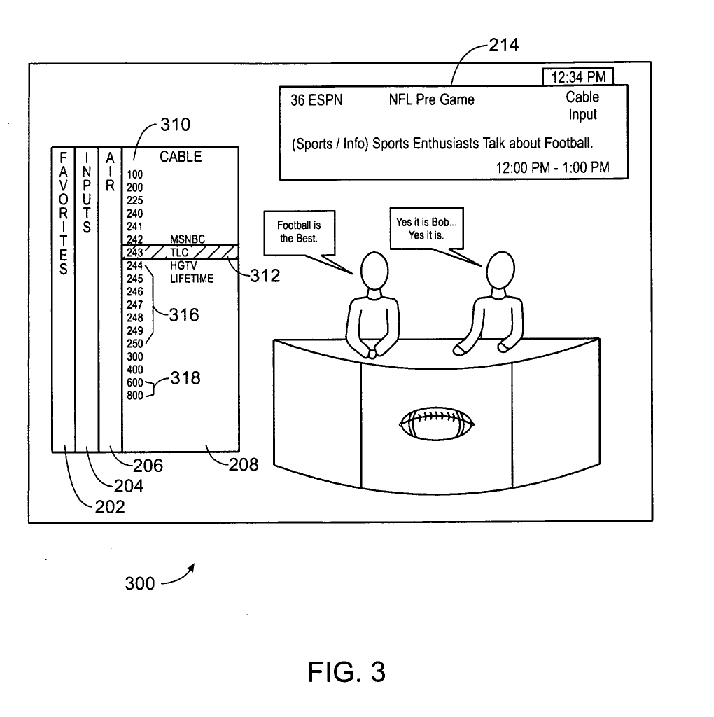

FIG. 3 is a graphical representation of an on-screen user selection interface in accordance with an exemplary embodiment of the present invention. In FIG. 3, the on-screen user selection interface is generally referred to by the reference number 300. FIG. 3 is similar to FIG. 2, the difference being that FIG. 3 depicts a situation in which the user has scrolled to a new currently selected channel 312, but has not yet affirmatively indicated a decision to tune to the new currently selected channel. Accordingly, the currently selected channel 212 from FIG. 2 continues to be displayed on the screen in FIG. 3. The scrolling process to employed by the user has resulted in a new channel list 310 relative to the previous channel list 210 depicted in FIG. 2.

The currently selected channel 312 (not yet tuned) is TLC (The Learning Channel 243). A further indication that the new currently selected channel 312 has not yet been tuned in FIG. 3 is the fact that the content information window 214 is still displaying the information about the previous currently selected channel 212. In an alternative embodiment of the present invention, the content information window could display the information about the currently highlighted channel to give the user better feedback (e.g., program name, description, etc.) about the program on that channel. The channel for which the content information window 214 contains information could be a setting controllable by a user via a user preference menu setting. For the channels that are farther away from the current highlighted channel 312, a range indication 318 is displayed, rather than showing every channel one by one. Alternatively, the range indication may include a horizontal line or other label instead of indicating far-away channels with numbers by tens, twenties, hundreds, or the like.

In accordance with an exemplary embodiment of the present invention, the user may scan or scroll through the list of channels at a variable scan rate by using a remote control. Those of ordinary skill in the art will appreciate that other means of controlling the navigation rate may be employed, including using the channel scan buttons physically disposed on a television, cable box, or the like. This variable scan rate method permits the use of advanced remote control devices such as scroll wheels, joy-sticks, motion-based pointers, and the like. However, an exemplary system and method is also compatible with standard remote control devices, such as the menu-up-down-left-right-select remotes (UDLR remotes).

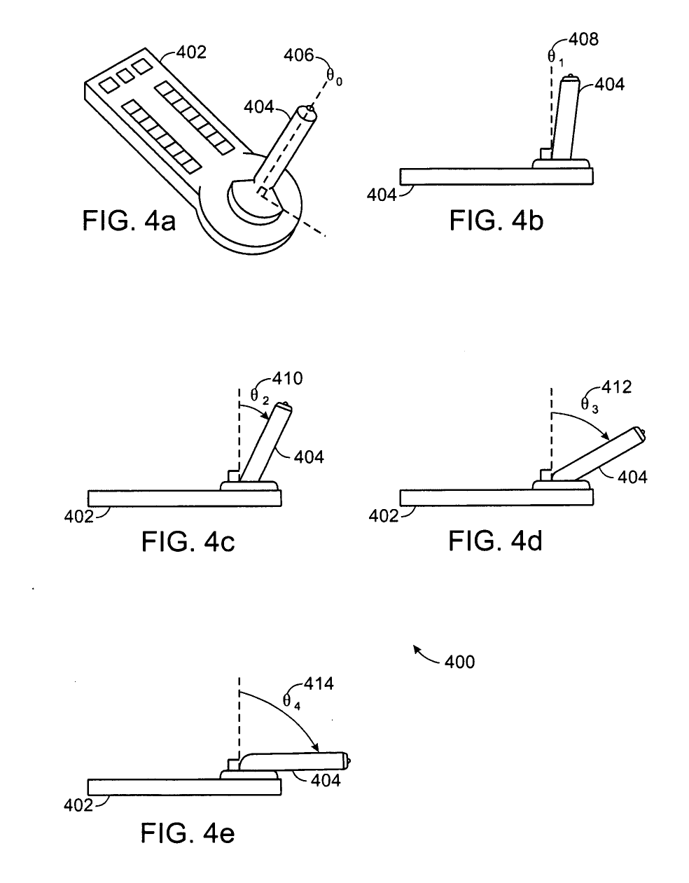

FIG. 4, which comprises FIGS. 4a-4e, is a graphical representation of a remote control device with a joy-stick for use in accordance with an exemplary embodiment of the present invention. The graphical representation is generally referred to by the reference number 400. FIG. 4 is useful in explaining the operation of a remote control device 402 in accordance with an exemplary embodiment of the present invention. The remote control device 402 is equipped with a joystick 404. As shown in FIG. 4a, an initial position 406 depicts the joystick 404 at a right angle (perpendicular) to the remote, i.e., at its equilibrium. At the initial position 406, an angle θ₀ between the joystick position and the vertical direction is 0 degrees. The joystick 404 is illustrated at successively larger angles θ₁-θ₄ from the initial position 406 in FIGS. 4b-4e. Specifically, the joystick is shown at a position 408 (θ₁) in FIG. 4b, at a position 410 (θ₂) in FIG. 4c, at a position 412 (θ₃) in FIG. 4d and at a position 414 (θ₄) in FIG. 4e.

The remote control 402 allows for a varying control signal to be sent to the television as the joystick 404 is moved to positions closer and farther from the equilibrium (for example, the positions 408, 410, 412 and 414 (FIGS. 4b-4e). Depending on the position of the joystick relative to equilibrium, the varying control signal will contain information indicating the desired channel scan or scroll rate through a list of channels such as the channel list 210 (FIG. 2). In an exemplary embodiment of the present invention, the user scrolls through the channel list 210 (FIG. 2) at an increasingly faster rate as the angle θ increases from θ₀-θ₄. For example, if the user positioned the joystick 404 to position 408, which is a small angle from the equilibrium, the lowest channel scan rate would be employed. As a result of choosing the lowest channel scan rate, software in the electronic device 100 would cause scanning of the channels at a rate of, for example, two channels per second. In this example, if the viewer chose to move the joystick 404 to position 410 (FIG. 4c), the software of the electronic device 100 would cause scanning of the channels at an increased rate of, for example, five channels per second. If the viewer chose to move the joystick 404 to the position 412 (FIG. 4d), the software of the electronic device 100 (FIG. 1) would cause scanning of the channels to increase to a faster rate of, for example, 15 channels per second. Finally, at a position 414 (FIG. 4e) channels could be scanned at a maximum rate of, for example, 50 channels per second. Those of ordinary skill in the art will appreciate that the different channel scan speeds given herein are exemplary. Different channel scan rates may be chosen depending on specific design considerations. In addition, the number of channel scan rate segments could be increased or decreased.

In an exemplary embodiment of the present invention, the joystick 404 may be used in channel selection as well as scanning. For example, after scanning channels at a rate of two channels per second, depicted at position 508, the viewer may release the joystick to its equilibrium position 506, where channel scanning would cease. If channel scanning ceased for a threshold amount of time, and thus the same channel was highlighted for the threshold amount of time, the channel may be automatically selected and tuned for viewing. Those of ordinary skill in the art will appreciate that to different methods of channel selection may be employed, such as the viewer having to press an enter or select button before a desired channel is selected and tuning is initiated.

As stated above, different types of advanced remotes may be used in accordance with an exemplary embodiment of the present invention. For example, a remote control may employ a scroll wheel instead of a joystick. With a scroll wheel, the number of up or down scroll commands in a certain sample time period could correspond to a given channel up or down scan rate. As such, the sample time period, as well as the number of scroll commands corresponding to a given channel scan rate may vary. Additionally, an exemplary embodiment of the present invention may maintain compatibility with known UDLR remote controls. For example, pressing the channel up or down button on the UDLR remote a certain number of times in a certain sample time period may correspond to a desired channel scan rate. Additionally, continuously holding the channel up or down button on the UDLR remote for certain varying time periods may correspond to different channel scan rates.

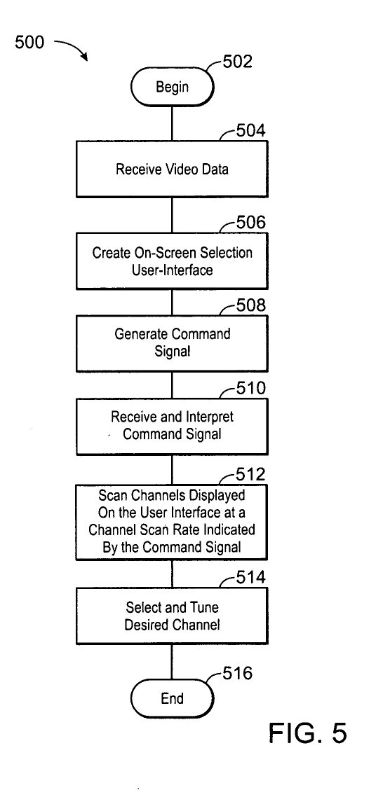

FIG. 5 is a process flow diagram of a method in accordance with an exemplary embodiment of the present invention. Specifically, FIG. 5 is an exemplary method of creating an on-screen user interface, scanning channels at a desired scan rate, and ultimately selecting a desired channel. At block 502, the process begins. Video data is received at block 504 and the on-screen user selection interface is created 506 and displayed to a user. At block 508, a scan rate command signal is generated containing information pertaining to the desired channel scan rate. In this example, at block 510, software of the electronic device 100 (FIG. 1) receives and interprets the command signal generated at block 508. At block 512, channels are scanned on the channel list 210 (FIG. 2) at the channel scan rate indicated by the command signal. At block 514, the desired channel is selected by the user and tuning to the selected channel is initiated. At block 516, the process ends.

As set forth above, the memory 108 (FIG. 1), which may comprise a tangible machine-readable medium, is adapted to store executable code or instructions that allow the processor 106 (FIG. 1) to control the operation of the electronic device 100 (FIG. 1). In accordance with an exemplary embodiment of the present invention, the memory 108 (FIG. 1) may store code adapted to receive a channel scan rate command signal that indicates a first channel scan rate or a second channel scan rate. Furthermore, the memory 108 (FIG. 1) may store code adapted to scan through a user interface display of a channel list at the first channel scan rate if the first channel scan rate is indicated by the channel scan rate command signal. The memory 108 (FIG. 1) may also store code adapted to scan through the user interface display of the channel list at the second channel scan rate if the second channel scan rate is indicated by the channel scan rate command signal. Finally, the memory 108 (FIG. 1) may store code adapted to display the user interface display.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of channel selection, comprising:
receiving a channel scan rate command signal that indicates a first channel scan rate or a second channel scan rate;
scanning through a user interface display of a channel list at the first channel scan rate if the first channel scan rate is indicated by the channel scan rate command signal; and
scanning through the user interface display of the channel list at the second channel scan rate if the second channel scan rate is indicated by the channel scan rate command signal.

2. The method recited in claim 1, comprising:
displaying as part of the channel list shown in the user interface display each channel for channels within a range of a currently selected channel; and
displaying as part of the channel list shown in the user interface display a single indication representative of a plurality of channels for channels outside of the range of the currently selected channel.

3. The method recited in claim 1, wherein the user interface display comprises a plurality of graphical tabs, each of the graphical tabs corresponding to a source type of video data.

4. The method recited in claim 1, wherein the first channel scan rate or the second channel scan rate is selected based on a position of a control element.

5. The method recited in claim 4, wherein the control element comprises a joystick.

6. The method recited in claim 1, wherein the first channel scan rate or the second channel scan rate is selected based upon a number of repeated commands.

7. The method recited in claim 6, wherein the number of repeated commands is transmitted using a scroll wheel.

8. The method recited in claim 1, wherein the channel scan rate command signal is received from a remote control.

9. The method recited in claim 1, comprising tuning to a selected channel upon receipt of an affirmative indication that tuning is desired by a user.

10. An electronic device, comprising:
a display; and
a processor adapted to:
receive a channel scan rate command signal that indicates a first channel scan rate or a second channel scan rate;
scan through a user interface display of a channel list displayed on the display at the first channel scan rate if the first channel scan rate is indicated by the channel scan rate command signal; and
scan through the user interface display of the channel list at the second channel scan rate if the second channel scan rate is indicated by the channel scan rate command signal.

11. The electronic device recited in claim 10, wherein the processor is adapted to:
display as part of the channel list shown in the user interface display each channel for channels within a range of a currently selected channel; and
display as part of the channel list shown in the user interface display a single indication representative of a plurality of channels for channels outside of the range of the currently selected channel.

12. The electronic device recited in claim 10, wherein the user interface display comprises a plurality of graphical tabs, each of the graphical tabs corresponding to a source type of video data.

13. The electronic device recited in claim 10, wherein the first channel scan rate or the second channel scan rate is selected based on a position of a control element.

14. The electronic device recited in claim 13, wherein the control element comprises a joystick.

15. The electronic device recited in claim 10, wherein the first channel scan rate or the second channel scan rate is selected based upon a number of repeated commands.

16. The electronic device recited in claim 15, wherein the number of repeated commands is transmitted using a scroll wheel.

17. The electronic device recited in claim 10, wherein the channel scan rate command signal is received from a remote control.

18. The electronic device recited in claim 10, wherein the electronic device is a television.

19. A tangible machine-readable medium, comprising:
code adapted to receive a channel scan rate command signal that indicates a first channel scan rate or a second channel scan rate;
code adapted to scan through a user interface display of a channel list at the first channel scan rate if the first channel scan rate is indicated by the channel scan rate command signal; and
code adapted to scan through the user interface display of the channel list at the second channel scan rate if the second channel scan rate is indicated by the channel scan rate command signal.

20. The tangible machine-readable medium recited in claim 19, comprising code adapted to display the user interface display.
